(19) United States
(12) Patent Application Publication
(10) Pub. No.: US 2003/0116226 A1
(43) Pub. Date: Jun. 26, 2003

(54) Products from organic and refuse things(P.O.R.T.) set

(76) Inventor: Cesar G. Muncada, Sunnyvale, CA (US)

Correspondence Address: CESAR G. MUNCADA, 1225 PECOS WAY, SUNNYVALE, CA, 94089, US

(21) Appl. No.: 09/962,575

(22) Filed: Sep. 24, 2001

(51) Int. Cl. B27M 1/00; B27M 3/00

(52) U.S. Cl. 144/329

(57) ABSTRACT

A natural form of coconut shells is individually or in combination with bamboo tubings made and designed into containers complimented, enhanced and supported by refuse synthetic containers fastened by rivets or other means which become another new form of device or container with utilitarian applications harnessing renewable and trash materials serving human necessities, helping the environment.

A product from organic and refuse things (P.O.R.T.) set includes a bamboo node slotted at the bottom to accommodate with magnets shown on pictures, a designed and slotted coconut shell attached to the said node top by a spring to keep it in place with flexibilities. A bamboo main trunk coming out of the node clean, shape, curved, to form the turtleneck and head, a synthetic buttons that make the eyes in different colors with the main bamboo branch or trunk front cut or slotted to from the mouth. The clean, curved, slotted turtle back shell out of coconut shell designed to depict, mimic, portray a genuine turtle appearance. The optional wheels slot facilitated toy provision application. The differential products that came out of (P.O.R.T.) set product are individual products themselves out of similar, identical and related materials used by the (P.O.R.T.) set; as in name plate/police paraphenalia, carousel safe keeper, roofing sectional module, tool pouch, and clothes hanger and turtle like toy.

### P.O.R.T SET

### BACKGROUND OF INVENTION

1. Field of the Invention

The only distinct invention out of organic materials and refuse things, particularly relates to a combine bamboo node, bamboo splits, soft drink plastic container, bamboo split roofing covering, loofa (patola), threaded rod or pipe, slotted coconut shell, magnets, nuts, washers, springs, platform base, nails, screws, bolts, and curved timber that support a sectional rope; the bamboo node and shell, that forms the turtle, the loofa that became a tool pouch, the bamboo splits and threaded rod or shaft that forms the clothes hanger and organizing carousel.

2. Description of the Prior Art

A painstaking search and research on several types of prior art has been conducted to uncover allayed fear of product duplication and potential infringement but nothing from the prior art files came close to the unobvious simplicity of the said P.O.R.T. product utilitarian applicabilities. Some prior art examples and illustration manifested no utilitarian combination of coconut shell and bamboo split material with threaded rod or threaded pipe aiding the formation of the most recent P.O.R.T. product. In Apr. 27, 1999 U.S. Pat. No. 5,896,903 U.S. patent issued to Chen Feng-Yuan. This patent discloses a method of fabricating a bamboo slots to make a bamboo blind. In Nov. 2, 1999 the U.S. patent issued U.S. Pat. No. 5,976,644 to Sanaee Bahaal Dean, a process of treating a bamboo. In Nov. 9, 1999 a U.S. patent issued U.S. Pat. No. 5,981,858 to Jing Jun Chan which discloses about a bamboo drum. In Aug. 15, 1978 U.S. patent office issued U.S. Pat. No. 4,107,383 to Reid Brian which discloses a coconut shell reduced into flour filler for electric cable insulation. In Apr. 18, 2000 U.S. patent issued U.S. Pat. No. 6,051,764 to Sakurai Hiroshi which discloses a string musical instrument out of bamboo plates. In Dec. 22, 1981 U.S. patent issued U.S. Pat. No. 4,307,120 to Conrado Escudero which discloses a method of repairing a dried coconut meat. The above mentioned method, process, devices, and gadgetries while appropriate for their intended purposes.

### SUMMARY OF THE INVENTION

In view of the differential qualities and operational enormous disparity of the above mentioned now prior art, the very recent invention a portable container carousel, roofing section, turtle toy, pouch and clothes hanger out of bamboo split, coconut shell and recyclable things combine made this improve unique product (P.O.R.T.) set.

To attend these representatives embodiment of the most recent invention shown and illustrated at the pictures from one through thirty-six. The turtle like assembly from the above mentioned materials combination offers benefits to our environment in terms of energy savings and oxygen generation. The nameplate, police paraphenalia and neck tie clip simplify the process and method in material application, product manufacturing friendly to our environment. The clothes hanger carved out of bamboo supported by a threaded rod or hook provides a means of separating and organizing wardrobe arrangement. The sectional roofing structure aided by wood screws, timbers and recyclable plastic materials can surely bring down the cost in house construction. The carousel like container/organizer supported by portable base mounted and staggered along the height of the threaded rod makes more sense to a cluttered kitchen. The tool pouch and parts container out of loofa (patola) materials are another tremendous cost savings and benefits of ecological invigoration to our society. Even more so it offers a special benefit to space application due to its inherent lightness and natural fiber resiliency.

The invention, unobviousness in its conceptual design, structural, functional and operational features, offers various novel characteristics and improvements not found in prior art. Maybe, the maximum potential capabilities of said P.O.R.T. product cannot as fully, yet be exhaustedly explored. However, in the interest of the continuing quality of improvement which the public deserves, the merits and benefits of the invention with each inherent advantages, should pave a way into third world local Barangay or Barrio manufacturing industry. Relative to the optional features desired, the invention should sell at a very minimum reasonable cost. The objective of the invention is to offer and improve, flexible, portable, product out of refuse things and renewable materials conducive to our environment requirements.

It has been outlined, rather broadly, the more important features of the invention in order that the detailed description therof that follows may better understood, so that the recent contribution to the art be clearly illustrated. There are, of course, additional features of the invention that will be describe here after and which will form the subject matter of the claims appended hereto. In this regard, before explaining at least one embodiment of the invention in detail, it is to be understood that the invention is not limited in its application to the detail of construction and to the arrangement of the component parts set forth in the following description and black and white illustration from number one through thirty-six copies of pictures submitted with the provisional application No. 60/235,111.

The invention is capable of other embodiments being practical and carried out in various ways. Likewise, it is to be understood that the semantics and phraseology utilized herein are for the purpose of description and should not be regarded as limiting. Those skilled in the art will appreciate the conception upon which this disclosure is base, which may readily be utilized as a basis for designing other purposes of the recent invention. Thus, the claim may be regarded as including such equivalents construction in so far as they do not depart from the spirit and scope of the recent invention.

It is therefore, the object of the recent invention to provide a new and improved portable product from organic and refuse things (P.O.R.T.) set which has all of the advantage over the prior art. It is further the object of the recent invention to achieve a quality, durable, and reliable product to enable owners transit conveniences and to organize safe keeping and shipping ease due to its detachability criterion which made the said (P.O.R.T.) set product compact and reasonably lasting with prudent use. These, together with the object of the invention, along with the various novelty feature pointed out in particularity in the claims annexed to and forming a part of the disclosure. For better understanding of the invention, its operating advantage and the specific object attained by its uses, reference should be made to the pictures submitted with provisional patent application No. 60/235,111.

### BRIEF DESCRIPTION OF THE PICTURES

The invention will be better understood and objects other than those set forth above will become apparent when consideration is given to the following detailed description thereof. Such description makes reference to the submitted pictures with said provisional application. Picture one shows and mimic a genuine turtle, the rest of the picture illustrate and support the accompanying embodiments showing and illustrating the other independent differential products out of said (P.O.R.T.) set through picture thirty-six.

### DESCRIPTION OF THE PREFERRED EMBODIMENT

With reference to the pictures one through thirty-six, and in particular to picture one, the turtle, the conceptual perceptiveness driven by principles, creativeness, where rather accidental in part as oppose to intentional personal desire to challenge human limits in developments failures and trials. The bamboo node wherein the said turtle use as base attached with coconut shell secured by mechanical means. The bamboo node main branch that naturally came cut from the said node where cut, curved, slotted, shape, and form to represent the turtle head. Likewise, the said node underside is optionally wheel provided to hasten ease in motion. The said loofa (patola) pouch presents and offers other unintentional benefits as in desk and washing sponge and general cleaning aid supply. Accordingly, it is slotted to hold and secured tools around human body held by strings or belts. The carousel out of coconut shells, bamboo splits held by said hardware on a threaded rod anchored and secured to a solid base offers safe keeping organization. The roofing module structure out of bamboo splits concavely and convexly arrange accordingly to prevent water in leaking through assembled and secured by said hardware on a corrugated timber means. The nameplate and police paraphenalia provided by a hook or pin or Velcro supension and hanging means in and around human clothing and uniforms.

What are claimed as being new and desired to be protected by Letters Patent of the U.S.A. are as follows:

1. A bamboo node its main branch cut, cleaned, shaped, formed, configured to mimic and reflect a genuine turtle appearance optionally attached with coconut shell on top, adjustably position by mechanical means wherein the top of said shell can flip flop, open or close, magnetize to accommodate load without falling, underneath slots for wheels mounting yet retained the appearance of a live turtle; a carousel support assembly to a combine coconut shell and bamboo split centrally supported or hung through a threaded rod anchored to a rigid base wherein nuts, washers, springs, staggered and secured along the height or length on vertical or horizontal position, a sectional roofing structure out of bamboo splits wherein slots options for sunlight propagation offers benefits in combination with synthetic recyclable materials utilize as barrier between the said bamboo split and rain water, concavely and convexly arrange to channel water down, secured, fastened, along a corrugated timber, following the bamboo splits contour using wood screws, nails, glue, sealers, bolts, ties, steel structural framing means ready for quick rigid modular installation; a cloth hanger out of bamboo tubes cut to length, slotted distributively around the said tube for clothing and underwear, safekeeping and organization, and elongated holes on the horizontal balance of the said tube is made for later adjustment with the hanger hook, a tool pouch/special part keeper, storage, handler out of loofa fibers cut, slotted to accommodate belt and special parts, shipping and transit cushion provider and aerospace works parts handler for its lightweight and inherent natural fiber resiliency aided by Velcro fastener for quick mount and dismount application as in car corners and crevices for useful space utilization, a name plate and police paraphernalia from a design, curve, letters printed surface on bamboo split coded with water proof varnish, cut to size coconut shell or bamboo split provided with pin at the back for hanging on necktie or clothes, the creativity employed in designing, harnessing, processing, assembling, supporting these said organic materials in combination with hardware and synthetic recyclable refuse materials result in various useful unique and unobvious product as pictures show form one to thirty six, as in the turtle toy, carousel safe keeper, sectional roofing module ready for installation, clothes hanger, tool pouch and special parts handler, name plate and police paraphernalia; all the above products mentioned are individual products which is a differential parts that constitute the title or name of the product (P.O.R.T.) set that translates into product from organic and refuse things.
a) The said bamboo splits are clean cut to length to maintain a horizontal balance provided by an elongated holes aided by nuts, washers, springs, along the height of a threaded rod or shaft to accommodate adjustment through the elongated hole to facilitate and hold multiple laundry natural drying
b) A cylindrical whole inter nodes bamboo, clean cut, routed, supported from elongated holes wherein horizontal balance adjustment from the said treated rod insures and accommodates clothes hanging application for multiple wardrobe storage of assorted undergarments
c) A much longer bamboo split chemically treated and covered by recyclable plastic topping covering, includes a structural timber means with the concave and convex adaptation from the split bamboo natural curve form secured by a roping nails, screws, ties, or bolt, layed concavely and convexly overlapping in an angular plane with synthetic or plastic toppings for water leaking prevention making it sectional roofing module ready for installation, a steel framing as an option for the said roofing in varieties of roofing application requirement
d) The said bamboo split and coconut shell combination mounted on a threaded rod secured and supported by the said base portable to be moved around depicting a carousel like application accommodating parts, systematic organization of parts, or safe keeping of kitchen or business shops ancillaries
e) A natural plant fiber loofa (patola) wherein a slotted holes are cut along each natural holes for waist belt suspension means, very light weight tool pouch for car corners and crevices space converted into usable application with the said loofa installation, a shipping box for transit cushion or special parts transport safe keeping
f) A bamboo split and coconut shell fragments clean, shape form, with back pin for nameplate and neck tie clip, cabinet drawer knob handle or furniture and table design application decorative
g) The cut, shape, form bamboo node in combination for design coconut shell held by a spring at the top of node slotted, notched, at the bottom for wheel rolling mounting for toy application
h) The support assembly of claim one where said base threaded rod mounted aided by washers, nuts, springs, and similar hardware, supporting said combination of coconut shell and bamboo split for carousel assembly.

2) The support assembly of claim one where said threaded rod can be a threaded pipe to enhance stability as it gets higher or longer with the said hardware.

3) The said nameplate, neck tie clip, drawer knob of claim one as shown on pictures are supported by pings, clip behind glued or etch to the said bamboo split or coconut shell fragments.

4) The toy like turtle of claim one are distributively nagnetize to maximize varieties of uses, for holding paper clips, screws, nuts, washers, business cards on the bamboo node, on slots plurality at the turtle back shell.

5) The designed turtle shell accommodate various features and configurations, holes, curve form, shape slot lines to carry business cards and mounting connectives to the said bamboo node to maximize space usefulness without sacrificing genuine aesthetic appearance of a live turtle.

6) The said turtle wheels or rollers are made out of a hone or polish coconut shell glued to from a layer of stuck shell supported by a bamboo shop held by a bushing fastened to the underneath of the bamboo node.

7) The said loofa pouch and car space organizer provider of claim one is optionally slotted attached with velcro for smooth and quick mounting on car space crevices or waist belt carrying parts pouch for special aerospace operation.

8) The combine installation and mounting of both coconut shell and bamboo split of claim one staggered accordingly along the height of the threaded rod or pipe with its supporting means accommodate unlimited spacing vertical or horizontal with ease in movement decterity.

9) The roofing structure sectional module which comprises a clean bamboo splits, recyclable plastic materials, curved timbers or metallic structures that support the split bamboo underneath, secured and fastened together position to drain rain water and protect leakage ready for installation as a sectional module aided by the above mentioned hardware or steel framing to hasten structural rigidity and modularity.To establish choice, the above split bamboo can be treated chemically to resist decay and coated with layers of plastic or much better polymers film all around the surface of the said bamboo split acting like a deal in the interest of reliability and natural beauty, preserving the roofing structural integrity.
